(19) United States
(12) Patent Application Publication
(10) Pub. No.: US 2014/0015654 A1
(43) Pub. Date: Jan. 16, 2014

(54) VEHICLE APPROACH NOTIFICATION UNIT

(71) Applicants: HAMANAKODENSO CO., LTD., Kosai-city (JP); DENSO CORPORATION, Kariya-city (JP)

(72) Inventors: Toshiaki Nakayama, Miyoshi-city (JP); Koji Suzuki, Hamamatsu-city (JP)

(21) Appl. No.: 13/915,021

(22) Filed: Jun. 11, 2013

(30) Foreign Application Priority Data
Jul. 11, 2012 (JP) 2012-155989

(51) Int. Cl. B60Q 5/00

(52) U.S. Cl. CPC B60Q 5/00
USPC 340/425.5

(57) ABSTRACT

A vehicle approach notification unit which notifies an approach of a vehicle has a first notification sound generator and a second notification sound generator. The first notification sound generator produces a notification sound including at least a high-frequency sound forward from the vehicle. The second notification sound generator produces a notification sound including at least a low-frequency sound downward from the vehicle.

### CROSS REFERENCE TO RELATED APPLICATION

This application is based on Japanese Patent Application No. 2012-155989 filed on Jul. 11, 2012, the disclosure of which is incorporated herein by reference in its entirety.

### TECHNICAL FIELD

The present disclosure relates to a vehicle approach notification unit.

### BACKGROUND

Conventionally, a vehicle approach notification unit notifies pedestrians of an approach of a vehicle with a notification sound. JP-A-10-201001 discloses such a vehicle approach notification unit having a dynamic speaker which directly produces a notification sound outside of a vehicle.

A notification sound produced by the dynamic speaker has directivity, and the directivity is defined by a nearly circular shape around the vehicle. The directivity may be referred as a sound field within which a sound having a predetermined sound pressure reaches from the dynamic speaker.

Due to the directivity, the notification sound may be not uniformly or equally audible to pedestrians around the vehicle. The notification sound may be difficult to be transmitted to a pedestrian in front of the vehicle compared with a pedestrian in side or back of the vehicle, although the pedestrian in front of the vehicle is in a traveling direction of the vehicle.

### SUMMARY

It is an object of the present disclosure to provide a vehicle approach notification unit which produces a notification sound that is audible to pedestrians who are around a vehicle, especially who are in front of the vehicle.

According to an example of the present disclosure, a vehicle approach notification unit which notifies an approach of a vehicle has a first notification sound generator and a second notification sound generator. The first notification sound generator produces a notification sound, which is defined by high-frequency sound, forward of the vehicle. The second notification sound generator produces a notification sound, which is defined by low-frequency sound, downward of the vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating a vehicle approach notification unit according to a first embodiment;

FIG. 2 is a block diagram illustrating the vehicle approach notification unit according to the first embodiment;

FIG. 3A is a schematic view illustrating a first case where a notification sound is emitted forward by a first notification sound generator of the vehicle approach notification unit;

FIG. 3B is a schematic view illustrating a second case where a notification sound is emitted downward by a second notification sound generator of the vehicle approach notification unit;

FIG. 3C is an explanatory view illustrating directivity of the notification sound in the first case and the second case;

FIG. 4A is a schematic view illustrating a vehicle approach notification unit according to a second embodiment; and

FIG. 4B is a schematic enlarged view illustrating first and second notification sound generators which are integrated together.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

When a predetermined driving condition to notify pedestrians of an approach of a vehicle is met, the vehicle approach notification unit produces a notification sound outside of the vehicle. The vehicle approach notification unit has a first notification sound generator 1 and a second notification sound generator 2. The first notification sound generator 1 produces a notification sound forward from the vehicle, and the notification sound includes at least high-frequency sound such as high pitch sound or ultra sonic sound. The second notification sound generator 2 produces a notification sound downward from the vehicle, and the notification sound includes at least low-frequency sound such as low pitch sound.

In a first embodiment, as shown in 2, the first notification sound generator 1 may have a first speaker 3, and the second notification sound generator 2 may have a second speaker 4. In this case, the notification sound produced by the first notification sound generator 1 and the notification sound produced by the second notification sound generator 2 may have the same frequency and the same phase. Alternatively, the frequency may be made different so as to change the tone color. Further, the phase also may be made different.

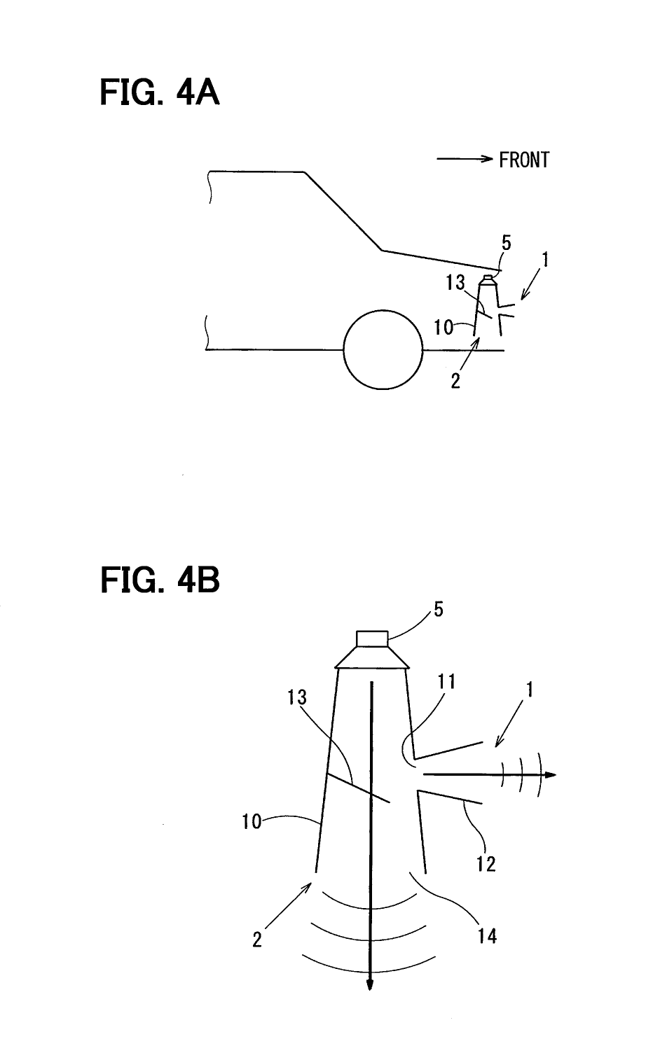

In a second embodiment, as shown in FIG. 4A, the first notification sound generator 1 and the second notification sound generator 2 may have a common speaker 5.

### First Embodiment

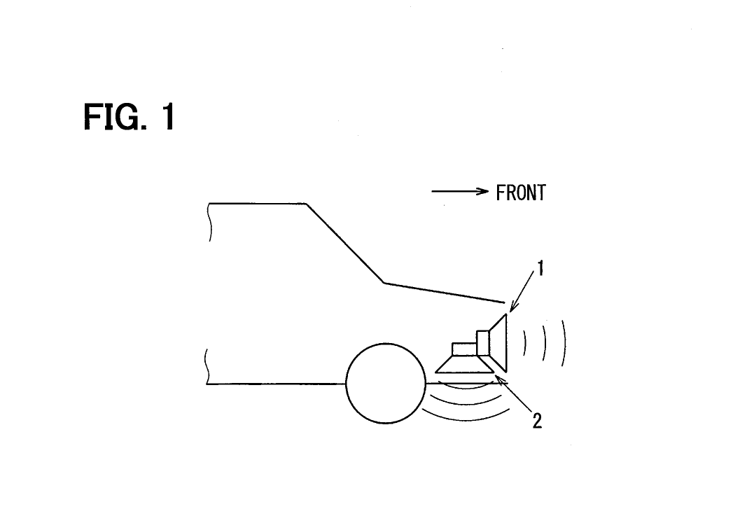

A first embodiment will be described with reference to FIGS. 1-3C.

A vehicle approach notification unit is disposed in a vehicle that may emit a quite sound during a drive time or a stop time. For example, the vehicle may be an electric vehicle or a fuel cell vehicle with no engine (i.e., no internal combustion engine). Also the vehicle may be a hybrid vehicle in which the engine is stopped at the drive time and the stop time, an idling stop vehicle in which the engine is stopped at the stop time, or an engine vehicle that drives quietly.

The vehicle approach notification unit has a notification sound generator. When a predetermined driving condition is met, the notification sound generator produces a notification sound such as artificial engine sound, chord, voice sound and music.

The vehicle approach notification unit has the first notification sound generator 1 and the second notification sound generator 2. The first notification sound generator 1 is arranged to produce a notification sound forward from inside the front grill. The notification sound produced by the first notification sound generator 1 includes at least high-frequency sound such as high pitch sound or ultra sonic sound. The second notification sound generator 2 produces a notification sound downward, and the notification sound includes at least low-frequency sound such as low pitch sound.

The first notification sound generator 1 and the second notification sound generator 2 are mounted separately.

The first notification sound generator 1 has the first speaker 3 and a first sound tube 3a. The first speaker 3 produces sound waves, and the first sound tube 3a emits the sound waves as a notification sound forward of the vehicle. The first speaker 3 may directly emit the notification sound forward of the vehicle without the first sound tube 3a.

The second notification sound generator 2 has the second speaker 4 and a second sound tube 4a. The second speaker 4 produces sound waves, and the second sound tube 4a emits the sound waves as a notification sound downward of the vehicle. Also the second speaker 4 may directly emit the notification sound downward of the vehicle without the second sound tube 4a.

Although mounting locations and mounting process of the first notification sound generator 1 and the second notification sound generator 2 are not limited, the first notification sound generator 1 and the second notification sound generator 2 may be arranged to a vehicle horn. The vehicle horn is mounted inside the front grill located on the front side of the vehicle. When an occupant of the vehicle operates a horn switch, the vehicle horn produces a warning sound.

The first notification sound generator 1 and the second notification sound generator 2 are mounted inside the front grill because the vehicle horn is mounted inside the front grill.

By mounting the vehicle horn inside the front grill, the first notification sound generator 1 is mounted to the vehicle to produce a notification sound forward of the vehicle, and the second notification sound generator 2 is mounted to the vehicle to produce a notification sound downward of the vehicle.

Although speaker types of the first speaker 3 and the second speaker 4 are not limited, for example, a dynamic speaker producing sound waves with audible frequency is employed as both the first speaker 3 and the second speaker 4.

The dynamic speaker may be a magnetic cone speaker or a magnetic domical speaker having a permanent magnet (stator) and a voice coil. The voice coil is supported to vibrate together with a diaphragm, and produces a magnetic force by being supplied with electricity. The diaphragm produces sound waves, which are compression air waves, depending on the voltage applied to the voice coil.

The first speaker 3 and the second speaker 4 may be made of the same speaker such as a full-range speaker, which produces from low pitch sound to high pitch sound.

Alternatively, the first speaker 3 may be a small speaker that is excel in producing high pitch sound, such as a tweeter whose diaphragm is small in weight. In this case, the second speaker 4 may be a large speaker that is excel in producing low pitch sound, such as a woofer whose diaphragm is large in area.

Alternatively, the second speaker 4 may also be a small speaker. In such a case, the second sound tube 4a may amplify low-frequency sound produced by the second speaker 4.

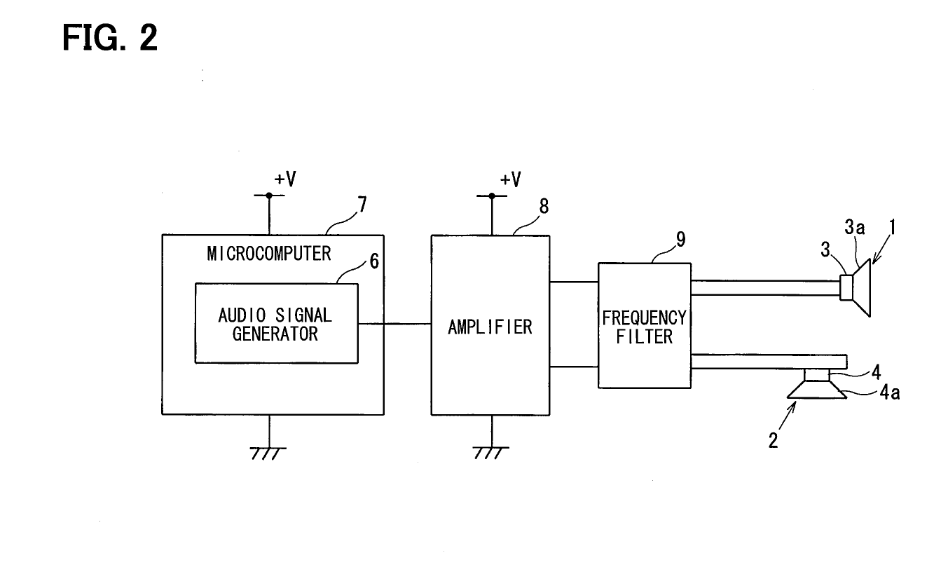

When a predetermined driving condition is met, the vehicle approach notification unit produces a notification sound such as artificial engine sound, chord, voice sound and music. As shown in FIG. 2, the vehicle approach notification unit has a control circuit actuating the first speaker 3 and the second speaker 4.

The vehicle approach notification unit has a microcomputer 7, an amplifier 8, and a frequency filter 9. The microcomputer 7 has an audio signal generator 6 producing an audio signal, which is an analog signal or a digital signal, to produce the notification sound. The amplifier 8 amplifies the audio signal. Due to the frequency filter 9, the first speaker 3 produces the high-frequency notification sound and the second speaker 4 produces the low-frequency notification sound.

An engine control unit (ECU) and the like inputs a signal including vehicle information such as vehicle speed to the microcomputer 7. On the basis of the vehicle information, the microcomputer 7 determines whether the predetermined driving condition is met or not. For example, when the vehicle is driving with speed under 20 km/h, the microcomputer 7 actuates the audio signal generator 6 to apply an audio signal to the amplifier 8.

The audio signal generator 6 is an acoustic software included in the microcomputer 7, and the audio signal includes frequencies from low, for example, lower than 1 kHz to high, for example, higher than 1 kHz.

That is, the audio signal produced by the audio signal generator 6 includes both a frequency signal producing the high-frequency sound and a frequency signal producing the low-frequency sound.

The amplifier 8 amplifies the audio signal produced by the audio signal generator 6, and actuates the first speaker 3 and the second speaker 4 with the amplified audio signal. For example, a B-class amplifier and a D-class amplifier are applicable to the amplifier 8.

The frequency filter 9 is a network-type frequency filter such as an inductance-capacitance (LC) filter having a coil and a capacitor, and located on an output side of the amplifier 8. The frequency filter 9 has a high-pass filter (low-cut filter) and a low-pass filter (high-cut filter). Due to the high-pass filter, a frequency signal with a predetermined level such as 1 kHz or higher is applied to the first speaker 3. Due to the low-pass filter, a frequency signal with a predetermined level such as 1 kHz or lower is applied to the second speaker 4.

However, the frequency filter 9 may be eliminated, or a capacitance-resistance (CR) filter located on an output side of the audio signal generator 6 may be employed as the frequency filter 9. In the latter case, for example, two of the amplifiers 8 may be provided to actuate the first speaker 3 and the second speaker 4, respectively.

As shown in FIG. 1, when the predetermined condition to notify pedestrians of an approach of the vehicle is met, the first notification sound generator 1 produces a high-frequency notification sound forward of the vehicle. At the same time, the second notification sound generator 2 produces a low-frequency notification sound downward of the vehicle.

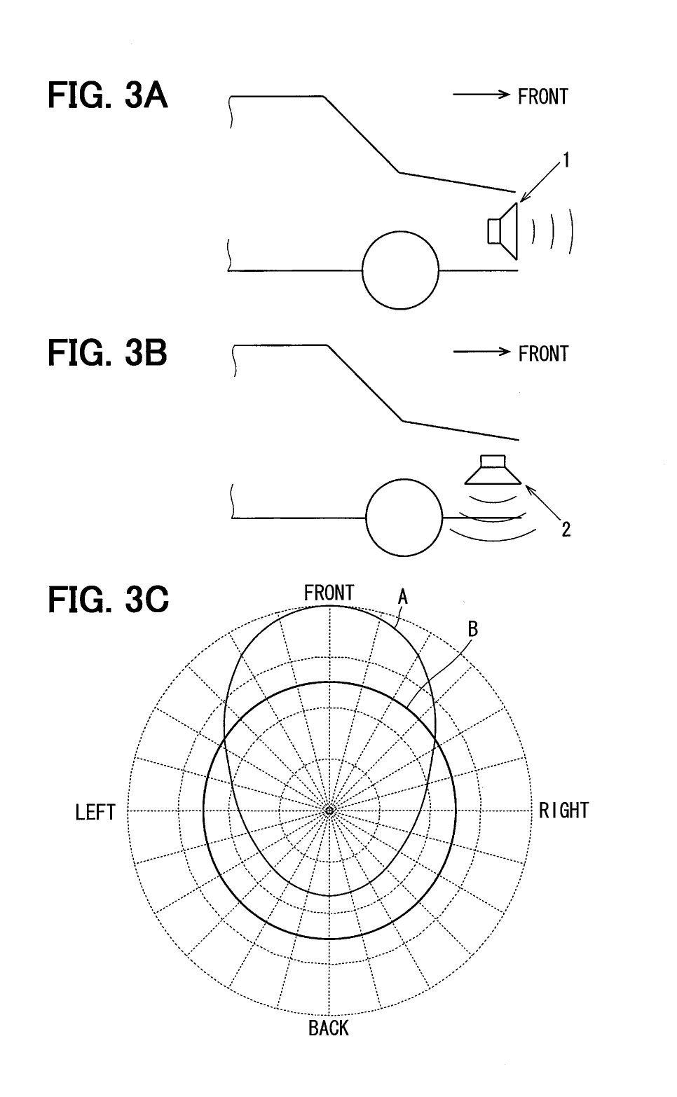

High-frequency sound has high directivity. As shown in a line A of FIG. 3C, the high-frequency sound travels forward within a predetermined forward range when the first notification sound generator 1 produces the high-frequency sound forward of the vehicle. The line A shows an overhead view illustrating a hearing range of high-frequency sound having a predetermined sound pressure, for example, 50 dB. Therefore, the notification sound produced by the first notification sound generator 1 reaches pedestrians, especially, who are in front of the vehicle.

In contrast, low-frequency sound has low directivity as shown in a line B of FIG. 3C. The low-frequency sound is reflected on the road, and travels widely around the vehicle when the second notification sound generator 2 produces the low-frequency sound downward of the vehicle. The line B shows an overhead view illustrating a hearing range of low-frequency sound having a predetermined sound pressure, for example, 50 dB. Therefore, the notification sound produced by the second notification sound generator 2 reaches pedestrians who are around the vehicle, especially, on the right or left side of the vehicle or behind the vehicle.

The first notification sound generator 1 of the vehicle approach notification unit produces at least high frequency notification sound forward from the vehicle. The high frequency notification sound may be high pitch sound in an audible frequency range or ultrasonic sound. The high frequency notification sound has high directivity, so the reach range can be controllable. Therefore, when the high frequency notification sound is produced forward from the vehicle, people in front of the vehicle can easily recognize the high frequency notification sound.

The second notification sound generator 2 of the vehicle approach notification unit produces at least low frequency notification sound downward to the road from the vehicle. The low frequency notification sound may be low pitch sound in an audible frequency range. The low frequency notification sound has low directivity, so the reach range can be made large. Therefore, when the low frequency notification sound is produced downward from the vehicle, people in side or back of the vehicle can easily recognize the low frequency notification sound.

Thus, the notification sound produced by the vehicle approach notification unit reaches pedestrians who are around the vehicle, especially, in front of the vehicle.

### Second Embodiment

A second embodiment will be described with reference to FIGS. 4A and 4B.

While the first notification sound generator 1 and the second notification sound generator 2 are mounted separately according to the first embodiment, the first notification sound generator 1 and the second notification generator 2 are integrated with each other according to the second embodiment.

Specifically, the first notification sound generator 1 and the second notification sound generator 2 are integrated by having a common speaker 5 and a common sound tube 10.

The first notification sound generator 1 has a front opening 11, a branched sound tube 12, and a reflective plate 13. The front opening 11 is defined in the common sound tube 10, and introduces the notification sound to come out of the common sound tube 10 forward into the branched sound tube 12. The branched sound tube 12 emits the notification sound forward of the vehicle. The reflective plate 13 is mounted inside the common sound tube 10 to reflect a part of the notification sound toward the front opening 11.

The second notification sound generator 2 has a lower opening 14. The lower opening 14 emits the notification sound downward out of the common sound tube 10 without being reflected by the reflective plate 13. Further, a low-frequency notification sound diffracting the reflective plate 13 and a low-frequency notification sound passing through the reflective plate 13 are emitted outside via the lower opening 14.

The common speaker 5 is provided to produce a notification sound that includes both low-frequency sound and high-frequency sound.

Although the common speaker 5 and the common sound tube 10 may be mounted to the vehicle horn as is the case with the first embodiment, the mounting locations are not limited to the vehicle horn.

When the predetermined driving condition is met, the common speaker 5 produces a notification sound that includes both low-frequency sound and high-frequency sound.

The high-frequency sound is reflected easily, so the notification sound with the high-frequency having high directivity is emitted forward via the front opening 11 after reflected by the reflective plate 13. Therefore, the notification sound with the high-frequency reaches pedestrians, especially, who are in front of the vehicle.

The low-frequency sound diffracts or passes through an object. So the notification sound with the low-frequency is emitted downward of the vehicle via the lower opening 14 of the common sound tube 10 after diffracting or passing through the reflective plate 13 without being reflected by the reflective plate 13. Then the low-frequency sound is reflected on the road and the like, and travels widely around the vehicle. Therefore, the notification sound with the low-frequency reaches pedestrians who are around the vehicle, especially, who are on the right or left side or behind the vehicle.

Thus, approximately the same advantages can be obtained in the second embodiment as the first embodiment. Furthermore, the first notification sound generator 1 and the second notification sound generator 2 are integrated by having the common speaker 5 and the common sound tube 10, so the producing cost of the vehicle approach notification unit can be reduced.

Although a straight sound tube is employed as the common sound tube 10 as shown in FIG. 4B, other sound tube having a spiral shape and the like can be applicable.

The first notification sound generator 1 may be plurally (for example, two) mounted to the vehicle. In this case, the hearing range of the notification sound can be controllable by controlling the mounting locations and directions of the first notification sound generators 1. In such a case, the hearing range of the notification sound can be controlled by controlling phases of the notification sounds produced by the first notification sound generators 1. For example, the phases can be made reverse (opposite) with each other.

Although a magnetic speaker actuated by magnetic force is employed as an example of the first speaker 3, the second speaker 4, and the common speaker 5, other speaker such as a piezoelectric speaker is applicable.

According to the first and the second embodiments, the first notification sound generator 1 produces a high-frequency notification sound having high frequencies in an audible range. Alternatively, the first notification sound generator 1 may be made of a parametric speaker. In this case, ultra sonic sound can be produced, and can be modulated into an audible frequency sound in the air so as to emit the notification sound forward of the vehicle.

Such changes and modifications are to be understood as being within the scope of the present disclosure as defined by the appended claims.

What is claimed is:

1. A vehicle approach notification unit which notifies an approach of a vehicle, the vehicle approach notification unit comprising:
a first notification sound generator which produces a first notification sound including at least a high-frequency sound forward from the vehicle; and
a second notification sound generator which produces a second notification sound including at least a low-frequency sound downward from the vehicle.

2. The vehicle approach notification unit according to claim 1, wherein
the first notification sound generator has a first speaker which produces the first notification sound forward from the vehicle, and
the second notification sound generator has a second speaker which produces the second notification sound downward from the vehicle.

3. The vehicle approach notification unit according to claim 1, wherein
the first notification sound generator and the second notification sound generator are integrated with each other by having a common speaker and a common sound tube, the common speaker producing the first notification sound and the second notification sound into the common sound tube,
the first notification sound generator has
a reflective plate arranged inside the common sound tube, the reflective plate reflecting the first notification sound in the common sound tube; and
a front opening defined on a front side of the common sound tube, the front opening emitting the first notification sound reflected by the reflective plate forward from the vehicle, and
the second notification sound generator has
a lower opening defined on a lower side of the common sound tube, the lower opening emitting the second notification sound which diffracts or passes through the reflective plate without being reflected downward from the vehicle.
